(19) United States
(12) Patent Application Publication
(10) Pub. No.: US 2026/0147812 A1
(43) Pub. Date: May 28, 2026

(54) A MODULE AND METHOD FOR GENERATING AN ENHANCED RESPONSE USING A RETRIEVAL AUGMENTED GENERATION MODEL

(71) Applicant: CERTIS CISCO SECURITY PTE LTD, Singapore (SG)

(72) Inventors: Wai Kit NG, Singapore (SG); Poh Beng TAN, Singapore (SG); Keen Hon WONG, Singapore (SG)

(21) Appl. No.: 19/264,983

(22) Filed: Jul. 10, 2025

(30) Foreign Application Priority Data
Nov. 28, 2024 (SG) 10202403728S

(51) Int. Cl. G06F 16/334; G06F 16/332; G06F 40/289; G06F 40/30

(52) U.S. Cl. CPC G06F 16/3347; G06F 16/332; G06F 40/289; G06F 40/30

(57) ABSTRACT

This disclosure describes a computing module that is configured to generate an enhanced response using a retrieval augmented generation (RAG) model. The RAG model utilizes a large language model to generate the enhanced response document chunks that have been appended with relevant context and the domain-specific query.

### CROSS REFERENCE TO RELATED APPLICATION

This application claims the benefit of priority to Singapore patent application no. 10202403728S which was filed on 28 Nov. 2024, the contents of which are hereby incorporated by reference in its entirety for all purposes.

### TECHNICAL FIELD

This application relates to a computing module that is configured to generate an enhanced response for a retrieval augmented generation (RAG) model. The RAG model utilizes document chunks that have been appended with relevant context and the domain-specific query to generate the enhanced response.

### BACKGROUND

Employees in a company often have access to extensive volumes of specific types of data through both public and private networks. These resources allow employees to conduct searches to find information or answers to specific or broad inquiries on a range of security-related topics. The organization may maintain a vast repository of documents containing vital information, such as operational procedures, compliance guidelines, and security protocols, which employees can access and search as needed to retrieve relevant information.

For example, a security surveillance company may maintain a comprehensive library of security policies and procedures that collectively define and regulate its operations in a consistent manner. An employee of the company could use the information in this database to search for specific information, such as guidelines on response protocols for a potential breach or procedures for conducting routine security audits. Such a system would allow employees to find precise information related to their query without having to manually sort through an extensive collection of documents.

However, the efficiency of these information retrieval systems relies heavily on the specificity of the submitted query. When the query is too broad or vague, the system may generate an overwhelming number of search results, where a majority of the results may be inaccurate or irrelevant. In such situations, the employees may be presented with a large volume of potential documents, making it challenging to identify which results are most relevant to their specific inquiry.

As a result, employees may need to manually evaluate the relevance of each search result, which often involves reading through short snippets or summaries displayed on the search interface or accessing the full documents associated with each result. This process can be both time-consuming and inefficient, particularly when an employee must sift through numerous results to find the most accurate and applicable information regarding security policies or protocols to address a live issue.

In view of the above issues, various approaches have been proposed by those skilled in the art including the use of ontologies and knowledge graphs. While ontology-based systems may be used to organize information in structured formats, such systems often struggle with complex queries and are typically constrained by limited knowledge bases. This limitation hinders their ability to function as comprehensive, adaptable solutions for large-scale information retrieval and question-answering tasks. As for knowledge graphs, while this method offers a systematic way to represent intricate relationships and entities, they face inefficiencies when attempting to extract domain-specific information from raw data, thereby limiting their applicability for specialized domains.

To address these challenges, those skilled in the art have proposed the use of RAG models based on large language models for question-answering tasks. While RAG models show potential, they also introduce significant noise and they tend to hallucinate when provided with inaccurate relevant documents, impacting the precision and efficiency of the responses generated. Hence, those skilled in the art are constantly looking for ways to improve the performance of RAG models for such use cases.

### SUMMARY

In one aspect, the present application discloses a retrieval augmented generation (RAG) computing module for generating an enhanced response to a user query. The disclosed module comprises a processing unit and a non-transitory media readable by the processing unit. The media stores instructions that when executed by the processing unit causes the processing unit to retrieve a plurality of documents from a database, generate a domain-specific query for each of the retrieved documents and append the generated domain-specific query to each of the respective retrieved documents and identify and extract relevant context from each of the retrieved documents and append the relevant context to each respective retrieved document. The processing unit then applies a two-layer chunking process to each of the retrieved documents to generate a plurality of document chunks, wherein each of the document chunks include the appended domain-specific query and a relevant context associated with the retrieved document from which the document chunks were generated and converts each of the document chunks into vector embeddings using an embedding model, and stores the vector embeddings in a vector database. The processing unit then retrieves vector embeddings from the vector database that have similarity scores above a predetermined score, wherein the similarity score of each vector embedding is determined based on a measure of similarity between the vector embedding and a vector representation of the user query, recursively retrieves full documents associated with the retrieved vector embeddings and generates, using a first large language model (LLM), the enhanced response to the user query based on the retrieved full documents and the user query. The vector representation of the user query may be generated using the embedding model.

In embodiments of this aspect, before the instructions to generate the enhanced response using the first LLM, the instructions further comprise additional instructions for directing the processing unit to select an optimal document, using a second LLM, from the retrieved full documents, and classify the selected document as the full document.

In embodiments of this aspect, the instructions to recursively retrieve the full documents associated with the retrieved vector embeddings comprises instructions for directing the processing unit to analyze the document chunks associated with the retrieved vector embeddings using a generative language model to identify a document chunk most relevant to the user query, and recursively retrieve at least a full document corresponding to the identified document chunk.

In embodiments of this aspect, before the instructions to convert each of the document chunks into the vector embeddings and the user query into the vector representation, the instructions further comprise additional instructions for directing the processing unit to generate, for each document chunk, a sub-query specific to content of the document chunk using a second LLM, wherein the sub-query is generated based on information contained in the document chunk and all data appended to the document chunk, and append the generated sub-query to the document chunk.

In another aspect of the disclosure, the present application discloses a method for generating an enhanced response to a user query using a retrieval augmented generation (RAG) computing module. The disclosed method comprises the steps of retrieving a plurality of documents from a database, generating a domain-specific query for each of the retrieved documents and appending the generated domain-specific query to each of the respective retrieved documents. The method then includes the steps of identifying and extracting relevant context from each of the retrieved documents and appending the relevant context to each respective retrieved document. A two-layer chunking process is then applied to each of the retrieved documents to generate a plurality of document chunks, wherein each of the document chunks include the appended domain-specific query and a relevant context associated with the retrieved document from which the document chunks were generated. The method then includes the steps of converting each of the document chunks into vector embeddings using an embedding model and stores the vector embeddings in a vector database. The method then comprises the steps of retrieving vector embeddings from the vector database that have similarity scores above a predetermined score, wherein the similarity score of each vector embedding is determined based on a measure of similarity between the vector embedding and a vector representation of the user query, recursively retrieves full documents associated with the retrieved vector embeddings and generating, using a first large language model (LLM), the enhanced response to the user query based on the retrieved full documents and the user query.

### BRIEF DESCRIPTION OF THE DRAWINGS

Various embodiments of the present disclosure are described below with reference to the following drawings:

FIG. 1 illustrates a block diagram of components or modules that are provided within a computing device to perform the steps for generating an enhanced response to a user query using a retrieval augmented generation (RAG) method in accordance with embodiments of the present disclosure;

FIG. 2 illustrates a flow diagram showing a two-layer chunking process in accordance with embodiments of the present disclosure;

FIG. 3 illustrates a flow diagram depicting the conversion of document chunks into vector embeddings in accordance with embodiments of the present disclosure;

FIG. 4 illustrates a block diagram of components or modules that are provided within a computing device to perform the steps for generating an enhanced response to a user query using an RAG method whereby another LLM is used to select from the full documents an optimal document to be provided to a large language model (LLM) in accordance with embodiments of the present disclosure;

FIG. 5 illustrates a block diagram of components or modules that are provided within a computing device to perform the steps for generating an enhanced response to a user query using an RAG method whereby a LLM is used to identify a document chunk most relevant to the user query before this document chunk and its corresponding full document are provided to another LLM in accordance with embodiments of the present disclosure;

FIG. 6 illustrates a flow diagram depicting the generation and appending of sub-queries specific to each respective document chunk in accordance with embodiments of the present disclosure;

FIG. 7 illustrates a block diagram of a processing system for performing embodiments of the present disclosure;

FIG. 8 illustrates bar graphs showing the performance or accuracy scores of different RAG models;

FIG. 9 illustrates bar graphs showing the performance or accuracy scores of different RAG models when different variations of content are provided to the respective RAG models;

FIG. 10 illustrates the distribution of similarity scores for nodes (document chunks) retrieved by the computing module as part of the RAG process where the sample distribution of these similarity scores are plotted against a normal distribution;

FIG. 11 illustrates the distribution of similarity scores for nodes (document chunks) retrieved by the computing module as part of the RAG process where the range and confidence intervals associated with these scores are highlighted; and

FIG. 12 illustrates a flow chart showing the process for generating an enhanced response to a user query using the RAG module in accordance with embodiments of the disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

One skilled in the art will recognize that certain functional units in this description have been labelled as modules throughout the specification. The person skilled in the art will also recognize that a module may be implemented as circuits, logic chips or any sort of discrete component. Still further, one skilled in the art will also recognize that a module may be implemented in software which may then be executed by a variety of processor architectures. In embodiments of the disclosure, a module may also comprise computer instructions or executable code that may instruct a computer processor to carry out a sequence of events based on instructions received. The choice of the implementation of the modules is left as a design choice for a person skilled in the art and does not limit the scope of the claimed subject matter in any way.

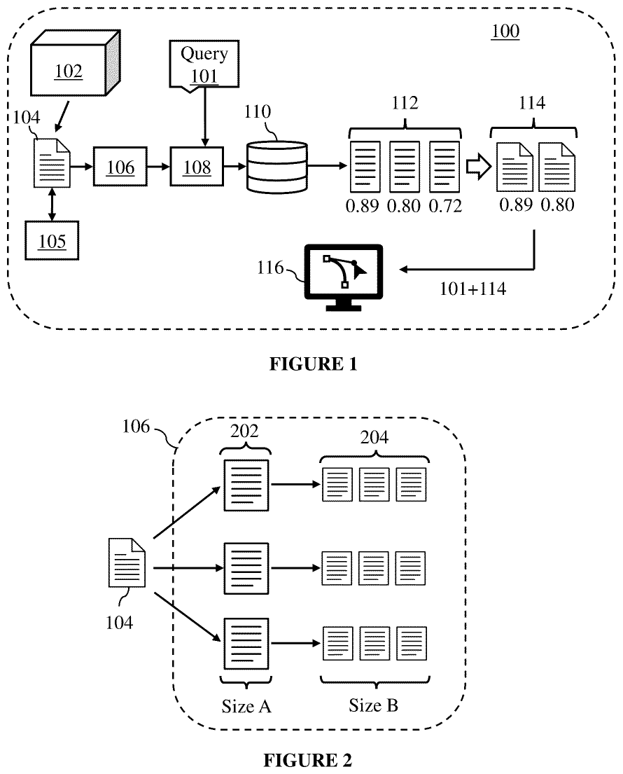

A retrieval augmented generation (RAG) computing module 100, which is designed to enhance the process of retrieving and generating responses based on relevant documents stored in a database is illustrated in FIG. 1. RAG computing module 100 comprise of several interconnected modules and processes that are configured to work together to transform a user query and a collection of documents related to the query into a contextually accurate and relevant response.

The process begins with computing module 100 retrieving relevant documents 104 from database 102. Database 102, which is used to store a vast collection of relevant information, may be provided within computing module 100 (as shown) or may be provided externally. Relevant documents 104 correspond to a specific domain or topic. In embodiments of the disclosure, domain-specific query 105 is generated for each of relevant documents 104, and domain-specific query 105 is appended to each respective relevant document 104. The generation of domain-specific query 105 may be done using a large language model or a generative language model. A domain-specific query that has been generated for a relevant document may comprise a question that is associated with the contents of the relevant document from which the query was generated from. In embodiments of the disclosure, the domain-specific query may be appended to each of the documents either in the text or the metadata of the document. When appended to the text of the document, the query may be provided at the beginning or end of the document. Conversely, the query can be appended as part of the metadata of the document, where it is then associated with the document without altering the actual text of the document. One skilled in the art will recognize that other methods may be used to append the extracted context to the documents without departing from this disclosure. This approach allows a subsequently used large language model (LLM) to directly incorporate the query into its contextual understanding of the document when embedding or generating responses based on the document, enhancing the relevance of the information retrieved.

In embodiments of the disclosure, relevant context from each of relevant documents 104 are identified, extracted and appended to each respective relevant document. The steps of identifying and extracting relevant context from each relevant document, before the extracted relevant context is appended to each respective relevant document involves a process that enriches each relevant document with pertinent information for accurate retrieval and response generation. Specifically, computing module 100 may process each relevant document using an LLM (Large Language Model) or a similar generative language model configured or trained to understand the semantic structure of the content of the relevant document. The selected model then proceeds to identify key entities, themes, and concepts within the relevant document that are most relevant to the overall context of the document and the query. In embodiments of the disclosure, this may include the steps of analyzing the relationships between sentences and paragraphs to determine which parts of the relevant document contain essential information.

Once the relevant context of a relevant document has been identified, computing module 100 then proceeds to extract these key elements, before it proceeds to summarize or isolate the most important details that provide clarity or additional understanding of the document's content. In embodiments of the disclosure, this extracted context may comprise definitions, related facts, or explanations that enhance the document's relevance to the domain-specific query. Once this is done, the extracted context is appended to each respective relevant document, either as an extension of the document's text, or as associated metadata. One skilled in the art will recognize that other methods may be used to append the extracted context to each respective relevant document without departing from this disclosure.

Each of the relevant documents 104, with the appended query, are then fed into two-layer chunking module 106 that has been designed to segment each of the documents into document chunks. During the two-layer chunking process, each of these documents are broken down into smaller, coherent pieces, enabling efficient processing in subsequent stages. In this process, the previously appended query and a relevant context associated with the relevant document from which the document chunks were generated are also incorporated into each of these document chunks to maintain context and relevance. In embodiments of the disclosure, each document is initially segmented or chunked into a document chunk comprising 1024 tokens, and it is then further segmented or further chunked into a document chunk comprising 512 tokens. The specific implementation details of this two-layer chunking process as executed by module 106 is omitted for brevity as they are well understood by those skilled in the art.

FIG. 2 illustrates a flow diagram showing the two-layer chunking process in accordance with embodiments of the present disclosure. Specifically, this figure illustrates document 104 being processed by two-layer chunking module 106 into document chunks 202, with each document chunk containing Size A tokens. Document chunks 202 are then further segmented by module 106 into document chunks 204, whereby each document chunk contains Size B tokens. It should be noted that Size B comprises a numerical value smaller than Size A. In embodiments of the disclosure, Size A comprises 1024 tokens while Size B comprises 512 tokens.

Returning to FIG. 1, once document 104 has been segmented into document chunks by two-layer chunking module 106, at this stage, each of the document chunks may include the domain-specific query and a relevant context associated with the relevant document from which the document chunks were generated. Module 100 then employs embedding module 108 to convert each document chunk into a vector representation or vector embeddings. This transformation enables RAG computing module 100 to store, to later retrieve, and to then rank the document chunks based on their relevance to user query 101.

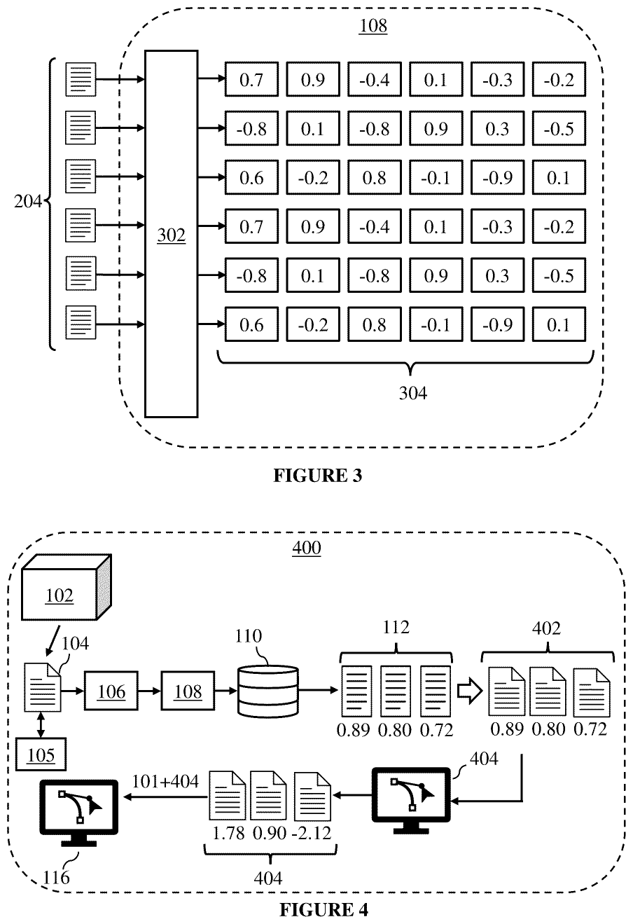

FIG. 3 illustrates a flow diagram depicting the conversion of document chunks 204 into their respective vector embeddings 304 using embedding model 302. In embodiments of the disclosure, embedding model 302 is configured to convert document chunks 204 into their respective vector embeddings 304 by transforming textual information into numerical representations that capture the semantic meaning of the text. The process begins with the document chunks being tokenized into smaller units, such as words or sub-words, using tokenization techniques such as, but are not limited to, open-source embedding model known to one skilled in the art, Byte-Pair Encoding (BPE) or Word-Piece. Embedding model 302 then processes these tokens through a series of layers, often involving neural networks like transformers, to produce high-dimensional vectors. The resulting vector embeddings represent the underlying relationships and context within each of the document chunks allowing embedding model 302 to capture not just the individual meanings of words but also their relationships and the overall structure of each of the document chunks. In embodiments of the disclosure, computing module 100 may utilize embedding module 108 to convert user query 101 into a vector representation.

In embodiments of the disclosure, the vector embeddings for each document chunk and the vector representation of the user query are typically represented as a fixed-size array of numbers, as illustrated in FIG. 3. These vector embeddings 304 are designed such that document chunks with similar meanings or contexts have vectors that are close to each other in the high-dimensional space, while those with different meanings are numerically located further apart. By converting the text into this numerical format, document chunks 204 may be effectively and efficiently compared with user query 101, allowing RAG computing module 100 to determine the relevance of each document chunk to the user query.

Returning to FIG. 1, it can be seen that vector embeddings of the document chunks are then stored in vector database 110, which serves as the central repository for all processed document vectors. After storing the vector embeddings, module 100 proceeds to assign a node score or a similarity score to each of the document chunks and this may be done by computing a similarity score between a document chunk and a vector representation of the user query. In the example illustrated in FIG. 1, it is shown that document chunks with the assigned similarity scores are illustrated as document chunks 112 (with similarity scores 0.89, 0.80, 072).

In embodiments of the disclosure, the similarity scores may be generated and assigned by computing a cosine similarity between the vector embeddings of each document chunk with the vector embeddings or representations of the user query. As is known to one skilled in the art, a cosine similarity measures the cosine of the angle between two vectors in the embedding space, producing a score between −1 and 1, where a score closer to 1 indicates a high similarity, meaning the document chunk is more relevant to the user query. The closer the vector embeddings (that are being compared) are in the embedding space, the higher the similarity score assigned to that document chunk. These similarity scores rank the document chunks in order of relevance to the query, allowing the system to prioritize the most relevant chunks for retrieval or further processing

Computing module 100 then proceeds to identify the highest-scoring document chunks 114 from document chunks 112, i.e. document chunks that have similarity scores above a predetermined score. In embodiments of the disclosure, this predetermined score comprises a score between 0.76 and 0.96, or preferably a score above 0.76 and the reasons for choosing these values are explained in the later sections below. In the example illustrated in FIG. 1, the highest-scoring document chunks 114 were those that have similarity scores of 0.89 and 0.82.

In the next phase, computing module 100 then performs a recursive retrieval process to access the full documents associated with the highest-scoring document chunks 114. It should be noted that during the recursive retrieval process, in embodiments of the disclosure, module 100 may be configured to identify additional related information or references within the initially retrieved full document associated with the identified document chunk. Module 100 then follows these links or references to obtain further documents, repeating this process until all relevant information has been retrieved or until a stopping condition is met (e.g., no more relevant links are found or a set retrieval depth is reached). This step ensures that comprehensive information from the original documents are available for the subsequent stages.

Computing module 100 then combines the user query 101 with the retrieved full documents associated with the highest-scoring document chunks 114. This combination is then provided to large language module LLM 116 so that LLM 116 may use this information to generate an enhanced response to user query 101.

In embodiments of the disclosure, the LLMs described in this disclosure may be trained through standard supervised or semi-supervised learning methods, where the LLM is exposed to vast amounts of text data from diverse sources. Additionally, the LLM may be fine-tuned on specific datasets that are aligned with the intended application of the LLM to enhance its ability to generate domain-specific and precise responses. The detailed training of such LLMs are omitted for brevity and they are understood by those skilled in the art.

FIG. 4 illustrates another embodiment of the disclosure whereby after module 100 has assigned similarity scores to each of the document chunks to produce document chunks 112 (with similarity scores 0.89, 0.80, 072), module 100 then proceeds to recursively retrieve full documents 402 associated with document chunks 112. This step ensures that comprehensive information from the original documents associated with all of document chunks 112 are available for the subsequent stages.

Computing module 100 then provides these retrieved full documents 402 together with user query 101 to LLM 404. In embodiments of the disclosure, LLM 404 comprises a large language model or a neural network that has been trained to refine the relevance of the document chunks by evaluating them, along with their associated full documents, in relation to the user query. The detailed training of LLM 404 is omitted for brevity as it is known to those skilled in the art. Once this process is completed, LLM 404 will assign relevance scores to each of these document chunks. LLM 404 achieves this by assessing both the immediate context of the chunk and the broader context provided by the full document. During this step, the LLM will consider the semantic relationships, context, and overall alignment of each of the document chunks and their associated full documents with the query before the selects from the retrieved full documents an optimal document for the user query.

In the example illustrated in FIG. 4, it can be seen that after LLM 404 has processed the document chunks and their associated full documents 402, LLM 404 generates document chunks 404—with the new relevance scores 1.78, 0.90 and −2.12 . A predetermined number of document chunks, e.g., the three document chunks that have the highest relevance scores, and/or document chunks having a relevance score above a predetermined score may then be selected from re-ranked document chunks 404 and may then be combined with the user query 101. The document chunk with the highest relevance score is determined to be the optimal document for the user query. This combination is then provided to LLM 116 so that LLM 116 may use this information to generate an enhanced response to user query 101. The selection of the predetermined number of chunks is left as a design choice to one skilled in the art.

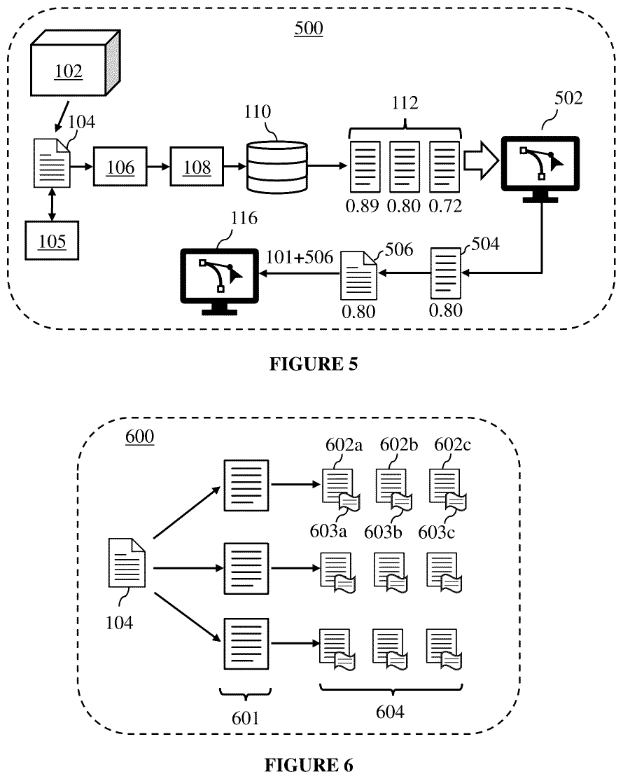

FIG. 5 illustrates yet another embodiment of the disclosure whereby after module 100 has assigned similarity scores to each of the document chunks to produce document chunks 112 (with similarity scores 0.89, 0.80, 072), module 100 then provides document chunks 112 to LLM 502. In embodiments of the disclosure, LLM 502 is configured to re-calculate or refine the similarity scores of each of retrieved document chunks based on the relevance of the document chunks (i.e., their respective similarity scores) to the user query. LLM 502 achieves this by analyzing the assigned scores, context and semantic relationships between the user query and the content within these document chunks. LLM 502 then assigns refined relevance scores to these document chunks. Computing module 100 or LLM 502 then proceeds to select the most relevant document chunk from these document chunks (that have the refined relevance scores). In the example shown in FIG. 5, document chunk 504 was identified to be the most relevant document chunk from document chunks 112.

Computing module 100 then proceeds to recursively retrieve full document 506 associated with document chunk 504. Retrieved full document 506, document chunk 504, and user query 101 are then provided to LLM 116 so that LLM 116 may use this information to generate an enhanced response to user query 101.

In yet another embodiment of the present disclosure, after the document chunks have been generated, computing module 100 may be configured to generate for each of the document chunks, a sub-query specific to content of the document chunk. The generation of each of these sub-queries for each respective document chunk may be performed by an LLM (not shown). The aim of generating sub-queries for each of these document chunks is to create a more specific, targeted question based on the content of each document chunk. This process typically starts with analyzing the context and key details within the document chunk to understand its primary themes, entities, and relationships. The LLM then combines this analysis with the original appended domain-specific query to ensure that the sub-query remains relevant while being tailored to the specific information found within the chunk.

Such an embodiment is illustrated in FIG. 6. As shown, after document 104 has been first segmented into document chunks 601 by two-layer chunking module 600, these document chunks are further segmented into smaller document chunks 604. Computing module 100 may then use an LLM to generate sub-queries for each of the document chunks based on information contained within each of document chunks 604 and the data that was previously appended to the document chunk, i.e., the domain-specific query and the relevant context associated with document 104 from which the document chunk was generated. Each of these sub-queries are then appended to each respective document chunk.

In the example illustrated in FIG. 6, it can be seen that sub-query 603a was generated based on document chunk 602a and was subsequently appended to document chunk 602a. Similarly, sub-query 603b and 603c were generated based on document chunks 602b and 602c respectively and were subsequently appended to document chunks 602b and 602c respectively. Once all the document chunks 604 have been appended with their respective sub-queries, computing module 100 then employs embedding module 108 to convert each document chunk into a vector representation as described in the various embodiments set out above. The vector embeddings may then be used in the embodiments illustrated in FIGS. 1, 4 and 5.

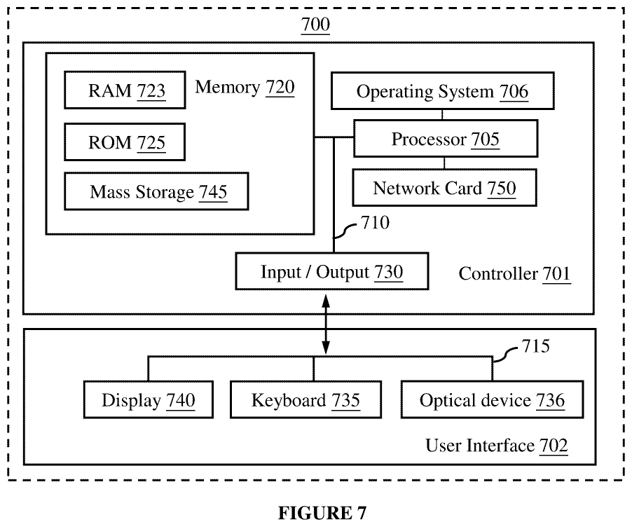

In accordance with embodiments of the present disclosure, a block diagram representative of components of processing system 700 that may be provided within computing module 100, and/or any of the modules shown in FIG. 1 to carry out the computing and processing functions in accordance with embodiments of the disclosure is shown in FIG. 7. One skilled in the art will recognize that the exact configuration of each processing system provided within these modules may be different and the exact configuration of processing system 700 may vary and the arrangement illustrated in FIG. 7 is provided by way of example only.

In embodiments of the disclosure, processing system 700 may comprise controller 701 and user interface 702. User interface 702 is arranged to enable manual interactions between a user and the computing module as required and for this purpose includes the input/output components required for the user to enter instructions to provide updates to each of these modules. A person skilled in the art will recognize that components of user interface 702 may vary from embodiment to embodiment but will typically include one or more of display 740, keyboard 735 and optical device 736.

Controller 701 is in data communication with user interface 702 via bus 715 and includes memory 720, processing unit or processor 705 mounted on a circuit board that processes instructions and data for performing the method of this embodiment, an operating system 706, an input/output (I/O) interface 730 for communicating with user interface 702 and a communications interface, in this embodiment in the form of a network card 750. Network card 750 may, for example, be utilized to send data from these modules via a wired or wireless network to other processing devices or to receive data via the wired or wireless network. Wireless networks that may be utilized by network card 750 include, but are not limited to, Wireless-Fidelity (Wi-Fi), Bluetooth, Near Field Communication (NFC), cellular networks, satellite networks, telecommunication networks, Wide Area Networks (WAN) etc.

Memory 720 and operating system 706 are in data communication with processor 705 via bus 710. The memory components include both volatile and non-volatile memory and more than one of each type of memory, including Random Access Memory (RAM) 723, Read Only Memory (ROM) 725 and a mass storage device 745, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 720 may include a kernel and/or programming modules such as a software application that may be stored in either volatile or non-volatile memory.

Herein the term “processor” or “processing unit” is used to refer generically to any device or component that can process such instructions and may include: a microprocessor, a processing unit, a microcontroller, a programmable logic device or other computational device. That is, processor 705 may be provided by any suitable logic circuitry for receiving inputs, processing them in accordance with instructions stored in memory and generating outputs (for example to the memory components or on display 740). In this embodiment, processor 705 may be a single core or multi-core processor with memory addressable space. In one example, processor 705 may be multi-core, comprising—for example—an 8 core CPU. In another example, it could be a cluster of CPU cores operating in parallel to accelerate computations.

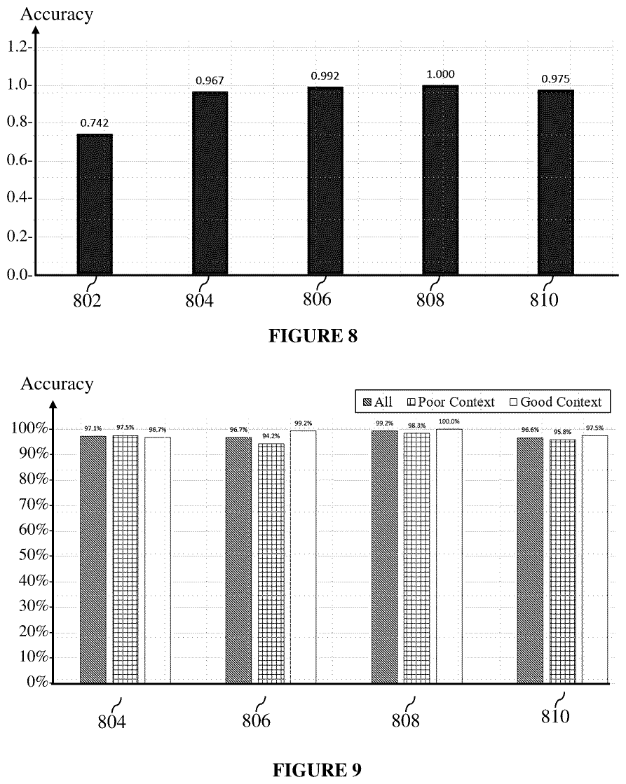

A comparison of accuracy scores for various RAG models are illustrated in FIG. 8. The x-axis sets out the various configurations of the RAG models, starting with a standard RAG model 802 that is known to those skilled in the art, and progressing through to RAG model 804 whereby the context of the relevant document have been appended to each respective document chunk, RAG model 806 whereby the domain-specific query has been generated and appended to each respective document, RAG model 808 whereby the context of the relevant document and the domain-specific query have been generated and are both appended to each respective document chunk that has a size of 512 tokens, and RAG model 810 whereby the context of the relevant document and the domain-specific query have been generated and are both appended to each respective document chunk that has a size of 256 tokens. It should be noted that RAG models 808 and 810 were disclosed in detail in the embodiments described in the previous sections. The bar graphs show the performance of each of the RAG models with the accuracy values labeled above each bar for clarity.

Based on these plots, it can be seen that RAG model 802 has the lowest accuracy score of 0.742 indicating that it is the least effective model as compared to the other models shown in this Figure. When the context of the relevant document are appended to each respective document chunk, it was found that the resulting RAG model 804 was able demonstrate an improvement in its accuracy scores. However, the highest accuracy was achieved by RAG model 808 in which the context of the relevant document and the domain-specific query are generated and both appended to each respective document chunk, where the size of each document chunk was set to 512 tokens. When the document chunk was reduced to 256 tokens, this resulted in a decrease in the accuracy of the RAG model (as shown by the accuracy score of RAG model 810). In summary, the bar graphs in FIG. 8 highlight the impact of different retrieval strategies and chunk sizes on the model's accuracy, emphasizing the importance of these parameters in order to achieve the optimum performance.

A comparison of accuracy scores for various RAG models are illustrated in FIG. 9 whereby each of the RAG models are provided with various contexts, ranging from poor context, good context, to a combination of both contexts, i.e. “all”. The x-axis sets out the various configurations of the RAG models, starting with RAG model 804 whereby the context of the relevant document have been appended to each respective document chunk, RAG model 806 whereby the domain-specific query for each relevant document has been generated and has been appended to each respective document, RAG model 808 whereby the context of the relevant document and the domain-specific query have been generated are both appended to each respective document chunk that has a size of 512 tokens, and RAG model 810 whereby the context of the relevant document and the domain-specific query have been generated and are both appended to each respective document chunk that has a size of 256 tokens.

The bar graphs show that the RAG models generally perform well across all contexts, with accuracy rates close to or above 95% for each configuration. However, it can clearly be seen that RAG model 808 achieved the highest performance, achieving a perfect 100% accuracy under good context conditions and high scores (99.2% and 98.3%) for all and poor context conditions, respectively. These results suggest that the model's chunk size and retrieval approach which involved the appending of the query and the relevant document's relevant context to the document chunk significantly influence accuracy, particularly when good contextual information is available.

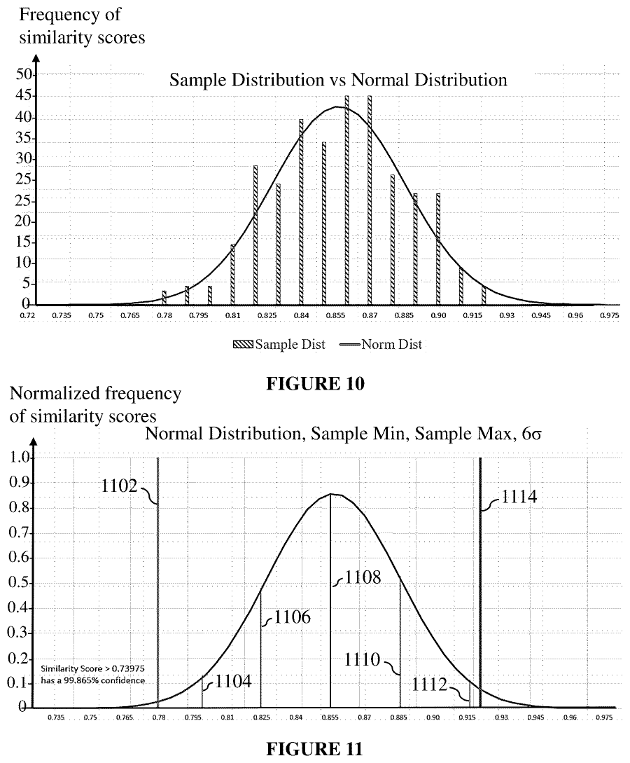

FIG. 10 illustrates the distribution of similarity scores for document chunks based on a sample dataset for the RAG model described in accordance with embodiments of this disclosure. The x-axis represents the similarity scores, ranging from 0.72 to 0.98, while the y-axis on the left shows the frequency of these scores within the sample. The bar graphs indicate the sample distribution, depicting how frequently each similarity score interval occurs while the curve represents a normal distribution, providing a reference to see how closely the sample data aligns with the expected bell-shaped curve.

The distribution shows that most node similarity scores are concentrated around the 0.83 to 0.88 range, suggesting that the majority of document chunks have a moderate to high relevance to the query based on the similarity calculation. The curve closely aligns with the sample distribution, indicating that the similarity scores follow an approximately normal distribution, with the highest frequency around the central peak. There are fewer instances of document chunks having extremely high or low similarity scores, and the frequencies taper off at the tails, consistent with the characteristics of a normal distribution. This pattern suggests that the RAG model described in accordance with embodiments of this disclosure performs as expected, generating a balanced spread of similarity scores with most nodes clustering around a central average.

Based on the same sample dataset, the distribution of the similarity scores for the document chunks are compared to a normal distribution curve and this is illustrated in FIG. 11. The x-axis represents the similarity scores, while the y-axis on the left of the chart displays the normalized frequency of similarity scores. The plot includes key markers: the Sample Min (line 1102) and Sample Max (line 1114), which indicate the lowest and highest observed similarity scores in the dataset. Additionally, standard deviations from the mean 1108 are marked at −2σ (1104), −σ (1106), σ (1108), and 2σ (1110) intervals, providing insight into the spread and confidence levels of the data. It is also annotated on the graph that a similarity score greater than 0.73975 has a 99.865% confidence level, suggesting that most of the nodes fall within this range, aligning well with the normal distribution curve depicted. This shows that when the predetermined similarity score is set to be more than 0.76, this would result in a sufficiently high confidence level in the relevancy of the document chunks.

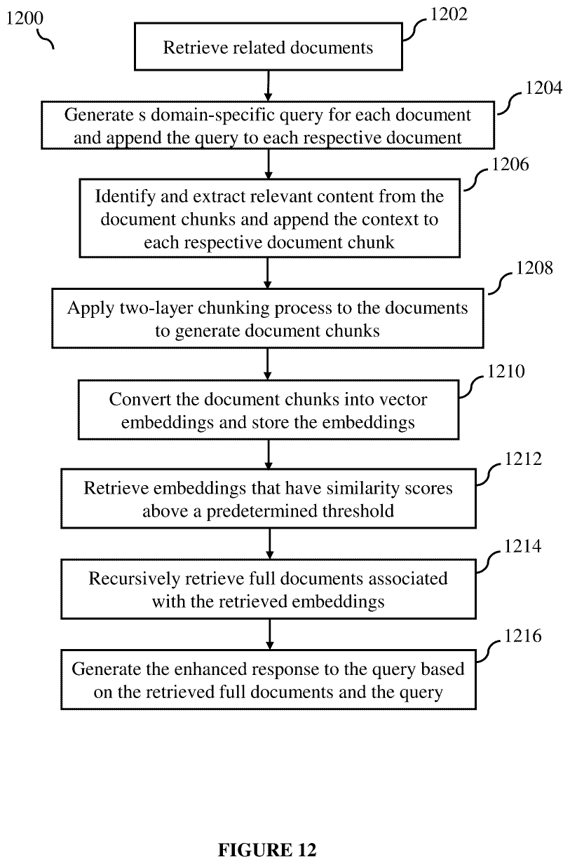

A flowchart which sets out the process for generating an enhanced response to a user query using a computing module in accordance with embodiments of the present disclosure is illustrated in FIG. 12. In embodiments of the disclosure, process 1200 as illustrated in FIG. 11 may be performed by computing module 100 or any combination of modules provided within computing device 100.

Process 1200 begins at step 1202 with process 1200 retrieving a plurality of documents from a database. At step 1204, process 1200 then generates a domain-specific query for each of the retrieved documents and appends the generated domain-specific query to each of the respective retrieved documents. At step 1206, relevant context is identified and extracted from each of the retrieved documents and then appended to each respective retrieved document.

Process 1200 then proceeds to apply a two-layer chunking process to each of the retrieved documents to generate a plurality of document chunks, wherein each of the document chunks include the appended domain-specific query and a relevant context associated with the retrieved document from which the document chunks were generated. This occurs at step 1208.

At step 1210, process 1200 then converts each of the document chunks into vector embeddings using an embedding model and stores the vector embeddings in a vector database. At this step, a user query is also converted into a vector representation using the embedding model and stored in the vector database. At step 1212, process 1200 then retrieves vector embeddings from the vector database that have similarity scores above a predetermined score and may assign these similarity scores to the respective document chunks associated with those vector embeddings, wherein the similarity score of each vector embedding is determined based on a measure of similarity between the vector embedding and the vector representation of the user query. At step 1214, process 1200 recursively retrieves full documents associated with the retrieved vector embeddings and/or document chunks and proceeds to step 1216. At this step, process 1200 generates, using a first LLM, the enhanced response to the user query based on the retrieved full documents and the user query.

In other embodiments of the disclosure, before process 1200 generates the enhanced response using the first LLM, process 1200 may use another LLM to select an optimal document for the user query and classify the selected document as the full document.

In other embodiments of the disclosure, when process 1200 recursively retrieves the full documents associated with the retrieved vector embeddings, process 1200 may analyze the document chunks associated with the retrieved vector embeddings using a generative language model to identify a document chunk most relevant to the user query, and recursively retrieve at least a full document corresponding to the identified document chunk.

In other embodiments of the disclosure, before process 1200 converts each of the document chunks into the vector embeddings, process 1200 may generate, for each document chunk, a sub-query specific to content of the document chunk using a second LLM, wherein the sub-query is generated based on information contained in the document chunk and all data appended to the document chunk, and process 1200 may then append the generated sub-query to the document chunk.

In other embodiments of the disclosure, when process 1200 recursively retrieves the full documents associated with the retrieved vector embeddings, process 1200 may analyze the document chunks associated with the retrieved vector embeddings using a generative language model to identify a document chunk most relevant to the user query, and retrieve and classify a blank document as a full document when the generative language model determines that none of the document chunks are relevant to the user query, wherein the first LLM is triggered to generate the enhanced response based solely on the user query and its pre-trained knowledge upon receiving the blank document classified as a full document.

In other embodiments of the disclosure, during the step of retrieving the plurality of documents, process 1200 may retrieve the plurality of documents and segment each of the plurality of documents into smaller and simpler documents using a large language model filter before process 1200 proceeds to step 1204.

In other embodiments of the disclosure, the identification and the extraction of the relevant context from each of the retrieved documents are performed using a generative large language model.

Numerous other changes, substitutions, variations, and modifications may be ascertained by the skilled in the art and it is intended that the present application encompass all such changes, substitutions, variations, and modifications as falling within the scope of the appended claims.

1. A retrieval augmented generation (RAG) computing module for generating an enhanced response to a user query, the module comprising:
a processing unit; and
a non-transitory media readable by the processing unit, the media storing instructions that when executed by the processing unit causes the processing unit to:
retrieve a plurality of documents from a database;
generate a domain specific query for each of the retrieved documents and append the generated domain-specific query to each of the respective retrieved documents;
identify and extract relevant context from each of the retrieved documents and append the relevant context to each respective retrieved document;
apply a two-layer chunking process to each of the retrieved documents to generate a plurality of document chunks, wherein each of the document chunks include the appended domain-specific query and a relevant context associated with the retrieved document from which the document chunks were generated;
convert each of the document chunks into vector embeddings using an embedding model, and store the vector embeddings in a vector database;
retrieve vector embeddings from the vector database that have similarity scores above a predetermined score, wherein a similarity score of each vector embedding is determined based on a measure of similarity between the vector embedding and a vector representation of the user query;
recursively retrieve full documents associated with the retrieved vector embeddings; and
generate, using a first large language model (LLM), the enhanced response to the user query based on the retrieved full documents and the user query.

2. The RAG computing module according to claim 1, wherein before the instructions to generate the enhanced response using the first LLM, the instructions further comprise additional instructions for directing the processing unit to:
select an optimal document, using a second LLM, from the retrieved full documents; and
classify the selected document as the full document.

3. The RAG computing module according to claim 1, wherein the instructions to recursively retrieve the full documents associated with the retrieved vector embeddings comprises instructions for directing the processing unit to:
analyze the document chunks associated with the retrieved vector embeddings using a generative language model to identify a document chunk most relevant to the user query; and
recursively retrieve at least a full document corresponding to the identified document chunk.

4. The RAG computing module according to claim 1, wherein before the instructions to convert each of the document chunks into the vector embeddings, the instructions further comprise additional instructions for directing the processing unit to:
generate, for each document chunk, a sub-query specific to content of the document chunk using a third LLM, wherein the sub-query is generated based on information contained in the document chunk and all data appended to the document chunk; and
append the generated sub-query to the document chunk.

5. The RAG computing module according to claim 1, wherein the plurality of document chunks each comprise 512 tokens.

6. The RAG computing module according to claim 1, wherein the predetermined score comprises a similarity score above 0.76.

7. The RAG computing module according to claim 1, wherein the instructions to recursively retrieve the full documents associated with the retrieved vector embeddings comprises instructions for directing the processing unit to:
analyze the document chunks associated with the retrieved vector embeddings using a generative language model to identify a document chunk most relevant to the user query; and
retrieve and classify a blank document as a full document when the generative language model determines that none of the document chunks are relevant to the user query, wherein the first LLM is triggered to generate the enhanced response based solely on the user query and its pre-trained knowledge upon receiving the blank document classified as a full document.

8. The RAG computing module according to claim 1, whereby the instructions to retrieve the plurality of documents from the database further comprise instructions for directing the processing unit to:
retrieve the plurality of documents; and
segment each of the plurality of documents into smaller and simpler documents using a large language model filter.

9. The RAG computing module according to claim 1, wherein the identification and the extraction of the relevant context from each of the document chunks and the generation of the domain specific query for each of the retrieved documents are performed using a generative large language model.

10. A method for generating an enhanced response to a user query using a retrieval augmented
generation (RAG) computing module, the method comprising:
retrieving a plurality of documents from a database;
generating a domain specific query for each of the retrieved documents and appending the generated domain-specific query to each respective retrieved document;
identifying and extracting relevant information from each of the retrieved documents and appending the relevant information to each respective document;
applying a two-layer chunking process to each of the retrieved documents to generate a plurality of document chunks, wherein each of the document chunks include the appended domain-specific query and a relevant context associated with the retrieved document from which the document chunks were generated;
identifying and extracting relevant context from each of the document chunks and appending the relevant context to each respective document chunk;
converting each of the document chunks into vector embeddings using an embedding model, and storing the vector embeddings in a vector database;
retrieving vector embeddings from the vector database that have similarity scores above a predetermined score, wherein a similarity score of each vector embedding is determined based on a measure of similarity between the vector embedding and a vector representation of the user query;
recursively retrieving full documents associated with the retrieved vector embeddings; and
generating, using a first large language model (LLM), the enhanced response to the user query based on the retrieved full documents and the user query.

11. The method according to claim 10, wherein before the step of generating the enhanced response using the first LLM, the method further comprises the steps of:
select an optimal document, using a second LLM, from the retrieved full documents; and
classifying the selected document as the full document.

12. The method according to claim 10, wherein the step of recursively retrieving the full documents associated with the retrieved vector embeddings comprises the steps of:
analyzing the document chunks associated with the retrieved vector embeddings using a generative language model to identify a document chunk most relevant to the user query; and
recursively retrieving at least a full document corresponding to the identified document chunk.

13. The method according to claim 10, wherein before the step of converting each of the document chunks into the vector, the method further comprises the steps of:
generating, for each document chunk, a sub-query specific to content of the document chunk using a third LLM, wherein the sub-query is generated based on information contained in the document chunk and all data appended to the document chunk; and
appending the generated sub-query to the document chunk.

14. The method according to claim 10, wherein the plurality of document chunks each comprise 512 tokens.

15. The method according to claim 10, wherein the predetermined score comprises a similarity score above 0.76.

16. The method according to claim 10, wherein the step of recursively retrieving the full documents associated with the retrieved vector embeddings comprises the steps of:
analyzing the document chunks associated with the retrieved vector embeddings using a generative language model to identify a document chunk most relevant to the user query; and
retrieving and classifying a blank document as a full document when the generative language model determines that none of the document chunks are relevant to the user query, wherein the first LLM is triggered to generate the enhanced response based solely on the user query and its pre-trained knowledge upon receiving the blank document classified as a full document.

17. The method according to claim 10, whereby the step of retrieving the plurality of documents from the database further comprises the steps of:
retrieving the plurality of documents; and
segmenting each of the plurality of documents into smaller and simpler documents using a large language model filter.

18. The method according to claim 11, wherein the identification and the extraction of the relevant context from each of the document chunks and the generation of the domain specific query for each of the retrieved documents are performed using a generative large language model.
